(19) United States
(12) Patent Application Publication
(10) Pub. No.: US 2008/0270906 A1
(43) Pub. Date: Oct. 30, 2008

(54) METHOD AND SYSTEM TO SHARE CONTENT

(76) Inventor: Venkateshwara N. Reddy, Cupertino, CA (US)

Correspondence Address: HAHN AND MOODLEY, LLP, P.O. BOX 52050, MINNEAPOLIS, MN, 55402, US

(21) Appl. No.: 11/740,377

(22) Filed: Apr. 26, 2007

(51) Int. Cl. G06F 3/00

(52) U.S. Cl. 715/733

(57) ABSTRACT

In one embodiment, a method is provided. The method comprises at the instance of a publishing user, receiving a location on a network at which content to be shared is located; making the location known to a group of users; and or each user in the group, providing an indication to the publishing user of whether that user has accessed the content.

### FIELD OF THE INVENTION

Embodiments of the invention relate to sharing content within a content network.

### BACKGROUND TO THE INVENTION

Content networks, such as the Internet, provide a wealth of content in the form is articles, news, blogs, image, video, music, etc. A location of content within the content network, for example on a server of the content network, may be specified by the now ubiquitous Uniform Resource Locator (URL). Sharing of particular content may be achieved by sharing the URL for the content.

### SUMMARY OF THE INVENTION

A method comprising:

at the instance of a publishing user, receiving a location on a network at which content to be shared is located;

making the location known to a group of users; and

for each user in the group, providing an indication to the publishing user of whether that user has accessed the content.

The method may further comprise determining if a user accesses the content within a predefined time period after the location was made known to the group. The method may provide that the indication comprises notifying the publishing user if the user accesses the content in the predefined period.

The method may further comprise receiving an already-viewed notification from a user in the group if the content has been accessed by that user before the location of the content was made known to the group.

The method may also provide that the indication comprises notifying the publishing user that the user accessed the content before the location of the content was made known to the group

The method may further comprise sending a reminder to any users in the group that have not accessed the content to access the content. The group may be predefined based on input received from the publishing user. The group may further be predefined based on subscription thereto by each of the users.

Further provided is a method, comprising:

receiving by a client computer of a user from a server a location at which content is located;

in a case of the content having been accessed by the user prior to the receiving then sending an already-viewed notification to the server to indicate that the content has already been accessed; and

in a case of the content being accessed by the user after the receiving then sending a viewed-notification to the server to indicate that the user has accessed the content.

The method may further comprise determining if the content was accessed prior to the receiving by searching a history (or activity log) associated with a browser of the client computer. The method may further comprising displaying log least one publish button in a browser of the client computer, and associating the publishing button with a publishing server.

The method may also comprise upon activation of the publish button by the user, sending the location of content currently being accessed by the browser to the publishing server. The method may further comprise allowing the user to add an annotation.

Also provided is a computer readable medium having stored thereon a sequence of instructions which when executed by a processing system causes the system to perform a method comprising:

at the instance of a publishing user, receiving a location on a network at which content to be shared is located;

making the location known to a group of users; and

for each user in the group, providing an indication to the publishing user of whether that user has accessed the content.

The method may further comprise determining if a user accesses the content within a predefined time period after the location was made known to the group. The method may also comprise notifying the publishing user if the user accesses the content in the predefined period.

The method may further comprise sending a reminder to any users in the group that have not accessed the content to access the content.

Additionally provided is a computer readable medium having stored thereon a sequence of instructions which when executed by a processing system causes the system to perform a method comprising:

receiving by a client computer of a user from a server, a location at which content is located;

in a case of the content having been accessed by the user prior to the receiving then sending an already-viewed notification to the server to indicate that the content has already been accessed; and

in a case of the content being accessed by the user after the receiving then sending a viewed-notification to the server to indicate that the user has accessed the content.

The method may further comprise determining if the content was accessed prior to the receiving by searching a history associated with a browser of the client computer. The method may further comprise displaying at least one publish button in a browser of the client computer, and associating the publishing button with a publishing server.

### BRIEF DESCRIPTION OF THE DRAWINGS

The invention is now described, by way of non-limiting example, with reference to the accompanying drawings wherein

FIG. 1 is a drawing of a network comprising a client computer and a server, in accordance with one embodiment of the invention;

FIG. 2 is a drawing showing some of the components of the client computer of FIG. 1;

FIG. 3 is a drawing showing some of the components of the server of FIG. 1;

FIG. 4 is a flowchart of operations performed by a publishing client of FIG. 2, in accordance with one embodiment of the invention;

FIG. 5 is a flowchart of operations performed by the publishing client of FIG. 2, in use, in accordance with one embodiment of the invention;

FIG. 6 is a drawing of a browser window for the publishing user, in accordance with one embodiment of the invention;

FIG. 7 is a flowchart of operations followed by a publishing manager of FIG. 3, according to one embodiment of the invention; and

FIG. 8 is a block diagram of hardware that may be used to implement the client computer or the server of FIG. 1, in accordance with one embodiment of the invention.

### DETAILED DESCRIPTION OF THE INVENTION

In the following description, for purposes of explanation, numerous specific details are set forth in order to provide a thorough understanding of the invention. It will be apparent, however to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the invention provide a method for sharing content such as articles, news, images, video, music, etc. located within a network such as the Internet. In one embodiment of the method for sharing content, a user (hereinafter “the publishing user”) may share content with a predefined group of users by simply navigating to the content using a browser and then selecting or activating a “publish button” to cause the location of the content within the network to be sent to a publishing server. The publishing server sends the location of the content to the users in the predefined group. The predefined group may or may not have members. Advantageously, this embodiment provides the publishing user with a mechanism to share content with a predefined group or community of users without having to embed the location of the content in a email message to each of the users in the predefined group. Further, the publishing server may be configured to provide a notification to the publishing user when the content is accessed by a user in the predefined group. Other advantages of the method for sharing content will be apparent from the description below.

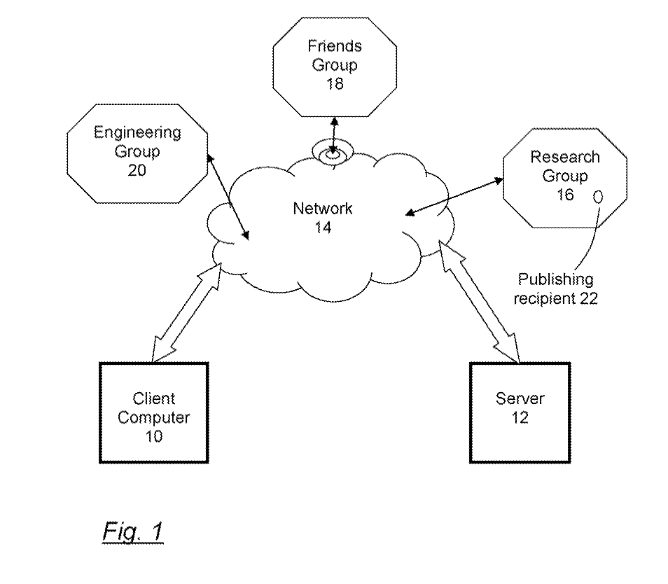

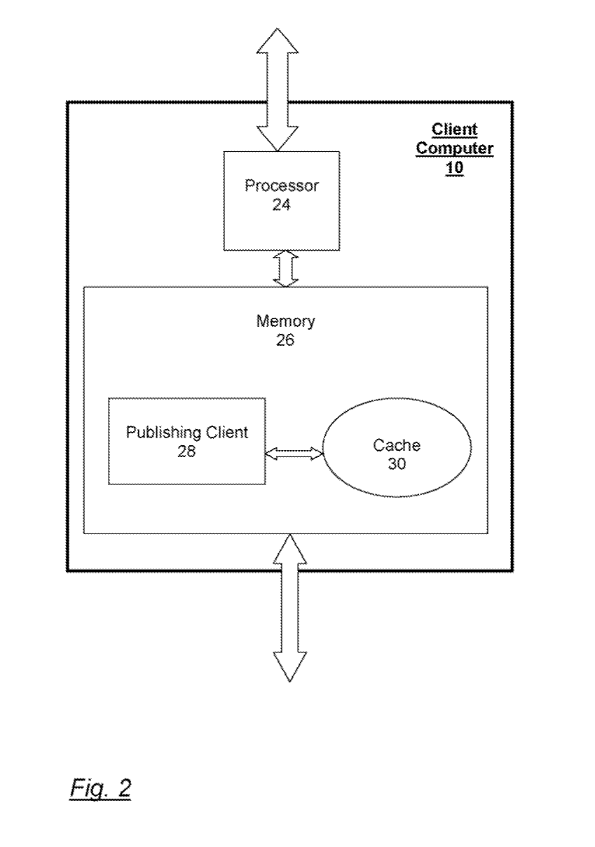

Turning now to FIG. 1 of the drawings there is shown a network 14 comprising a client computer 10, and a publishing server 12. In one embodiment, the client computer 10 and the publishing server 12 may be in accordance with a peer-to-peer relationship. As will be seen from FIG. 2, the client computer 10 may comprise a processor 24 coupled to a memory 26. The memory 26 comprises logic 28 to implement the functionality disclosed herein to publish or share content. For convenience, the logic 28 will be referred to as “the publishing client 28”. In one embodiment, the logic 28 may define a plug-in that may cooperate with a browser e.g. Microsoft™ Internet Explorer™, Netscape Navigator™, Mozilla Firefox™, Opera™, etc. The memory 26 may comprise a cache 30.

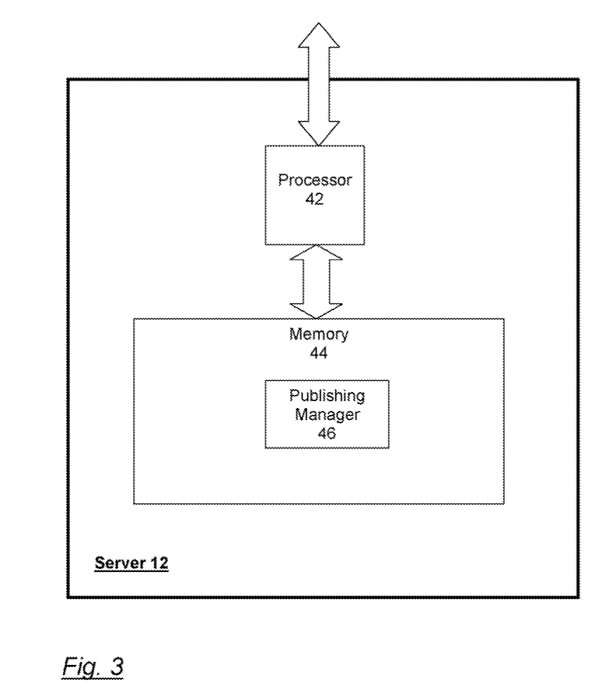

Referring now to FIG. 3, the server 12 may comprise a processor 42 in communication with a memory 44. The memory 44 may comprise logic 46 to implement the functionality disclosed herein to publish content to a predefined group of users. For convenience, the logic 46 will be referred to as the “publishing manager 46”.

The network 14 may comprise a Wide Area Network (WAN) architected in accordance with known network architectures. For example, the network 14 may comprise the Internet or the World Wide Web, in which case communications between the client computer 10 and the server 12 is in accordance with Transmission Control Protocol/Internet Protocol (TCP/IP). For the rest of this specification, for descriptive convenience and without loss of generality, the network 14 will comprise the Internet with a host of internet locations/nodes, such as websites, etc. Each node or location within the network 14 may be specified in terms of a URL (Uniform Resource Locator).

In one embodiment, content (also “shared content” hereinafter) may be published or shared with a predefined group of users (hereinafter also “the publishing group”). A publishing group may comprise any group of users that the publishing user may care to define for the purpose of publishing or sharing content with that group of users. Membership to a publishing group may be open or subscription based. For example, the publishing user may define publishing groups based on a particular relationship that the publishing user may enjoy with certain people. In one embodiment, the publishing user may define several relationship-based publication groups for the purpose of sharing pertinent or relevant content with members of each publication group. For purposes of this description, it is assumed that the publishing user has created the following predefined groups of users, namely a “Research” group 16, a “Friends” group 18, and an “Engineering” group 20, as shown in FIG. 1. For example, in one embodiment, the “Research” group 16 may comprise users that form part of a research team of which the publishing user is a member, the “Friends” group 18 may comprise users who are friends of the publishing user, the “Engineering” group 20 may comprise users who are part of an engineering team of which the publishing user is a member. It will be appreciated that content that the publishing user may wish to share with each of the above publishing groups will vary based on the group. Thus, by having several groups, each whose members are chosen based on a particular relationship with the publishing user, it is possible for the publishing user to publish content that is highly relevant to the group. The manner in which a group may be created will be described in greater detail below. For descriptive convenience, each user in a publishing group will also be referred to as a “publishing recipient”. For illustrative purposes, only a single publishing recipient in the “Research” group 16 is indicated by reference numeral 22.

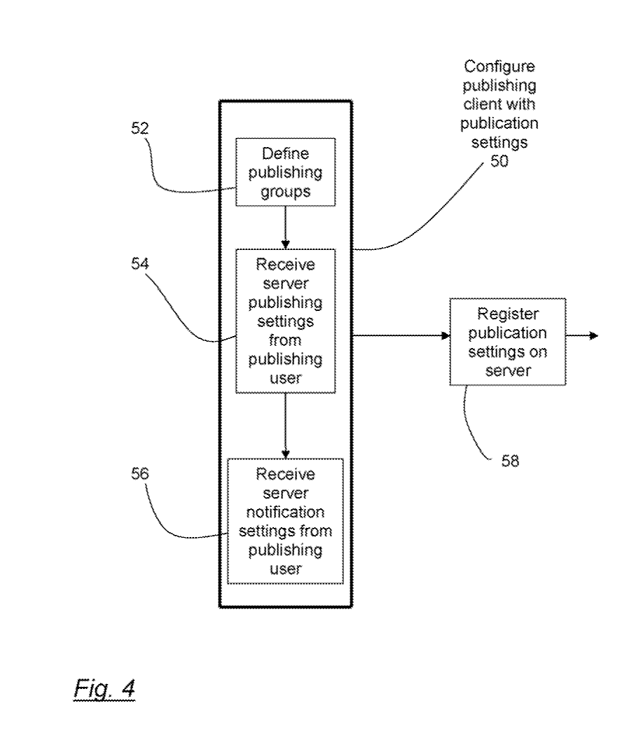

Referring now to FIG. 4, a flowchart of operations performed by the publishing client 10, in accordance with one embodiment of the invention, is shown. As will be seen, block 50 comprises a configuration block to configure the publishing client 10 with publication settings. The publication settings may comprise a setting to define the publishing groups for a particular publishing user, and server settings to control the manner in which the publication server publishes content to a publication group. Accordingly, the configuration block 50 comprises a block 52 to setup each publishing group. The block 52 may comprise receiving input from the publishing user to define and populate each publishing group that the publishing user wishes to create. In one embodiment, the publishing group may be automatically populated based on a pre-existing list. For example, the pre-existing list may be resident in a database. In one embodiment, the pre-existing list may be a clone of, for example, a distribution list from an e-mail client.

The block 50 may also comprise a block 54 to receive the server publishing settings from the publishing user. The server publishing settings may comprise a predefined period for which the publishing server 12 monitors which users in a group accesses shared content. The publishing settings may also comprise a setting to control a manner in which the content is published. For example, in one embodiment, the content may be published to the publishing group by being pushed out as an RSS (Rich Site Summary) feed to an internet location. In one embodiment, the content may be published by sending the URL inside an e-mail message to the publishing group.

In one embodiment, block 50 may comprise a block 56 to receive server notification settings to control a manner in which the publishing server 12 notifies the publishing user when a publishing recipient accesses shared content. For example, in one embodiment of the invention, the notification settings may be such that the publication server 12 sends an e-mail to the publishing user each time a publication recipient accesses shared content. The e-mail may specify a date and time that the shared content was accessed. In a further embodiment, the notification settings may be set to cause the publication server 12 to send an instant message to the publishing user when shared content is accessed. The notification settings may also comprise a setting to control a manner in which the publication server 12 sends a reminder to a publication recipient who did not access the shared content within the predefined period. For example, in one embodiment, the publishing server 12 sends an e-mail reminder to a publishing recipient. In one embodiment, the publishing server 12 sends an instant message reminder to the publishing recipient.

Information on each publishing group together with the server publishing and notification settings may be sent to the publication server 12, shown at block 58. By sending the information and settings to the server 12, the configuration of the publishing client 10 is registered on the server 12. Registering the publication settings of the publishing client 10 on the server 12 may allow the server 12 to perform its operations in a continuous manner without requiring input from the publishing user. Similarly, the configurations of the publishing client 10 may be re-registered on the server 12 when the publishing user changes the publication settings.

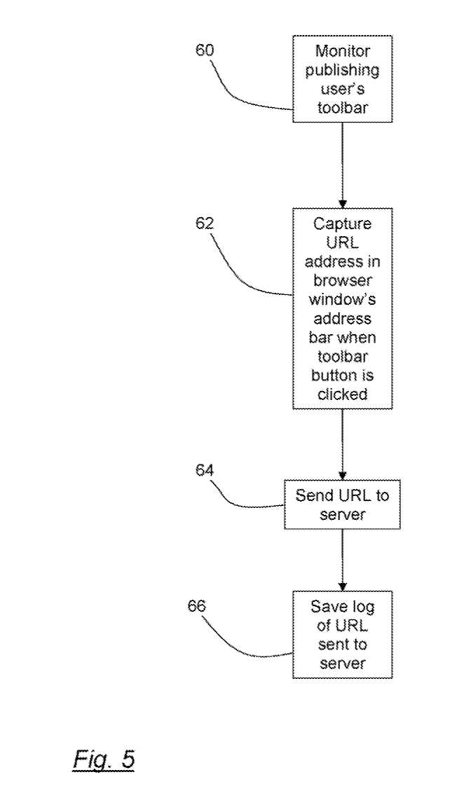

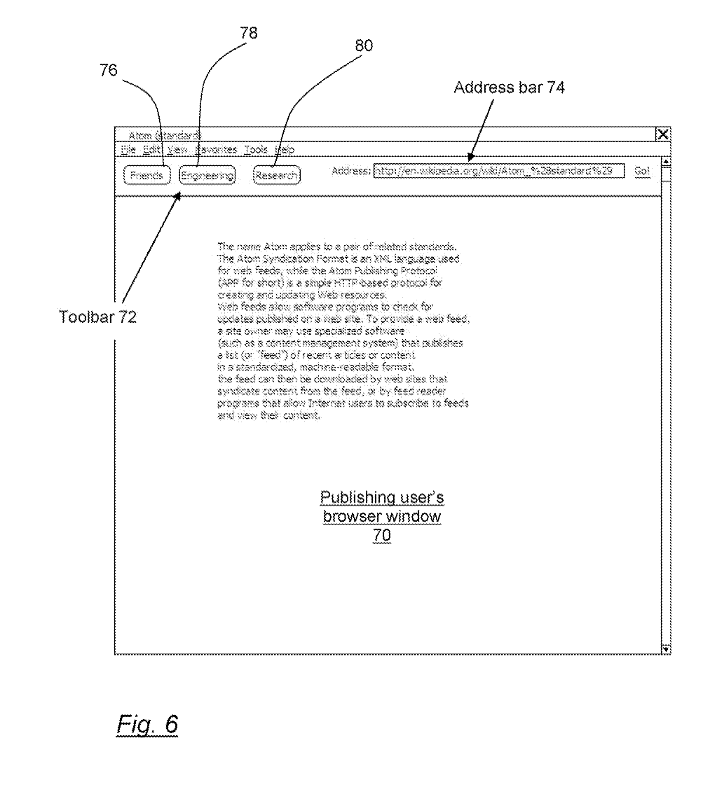

Once the configuration operation of the publishing client 10 and registration of such publication settings on the server 12 have taken place, the publishing client 28 may be used by the publishing user. The publishing user may use his/her browser to browse the network 14. FIG. 5 shows a flowchart of operations performed by the publishing client 28 in an embodiment of the invention. At block 60, the publishing 28 client monitors input from the publishing user. To explain one embodiment of how the publishing client 28 monitors for input, reference is made to FIG. 6. FIG. 6 shows a drawing of the publishing user's browser window 70. In one embodiment of the invention, as described above, the publishing client 10 generates a toolbar 72 in the browser window 70. In the embodiment shown, the toolbar 72 comprises a “Friends” button 76, an “Engineering” button 78, and a “Research” button 80. These buttons 76, 78 and 80 correspond to the predefined groups of users, as described above. Each button on the toolbar 72 relates to a particular group, e.g. the “Research” button relates to the “Research” group.

When the publishing user locates content he/she wants to share, the publishing user merely clicks the relevant toolbar button 76, 78, or 80 when the content is shown in the browser window 70. In the example shown, the browser window 70 is shown with content from the URL “http://en.wikipedia.org/wiki/Atom_%28standard%29” indicated in an address bar 74 of the browser window 70. For example, if the publishing user deems the content in the browser window 70 to be relevant to the “Research” group 16, the publishing user merely needs to click the “Research” button 80 on the toolbar 72. As indicated at block 62 of FIG. 5, when the relevant button 76, 78, or 80 of the publishing client 28 is clicked, the publishing client 28 captures the URL in the address bar 74, i.e. “http://en.wikipedia.org/wiki/Atom_%28standard%29” in the above example. At block 64, the publishing client 28 sends the captured URL to the server 12 via the network 14, along with an indication of the selected publishing group, e.g. “Research” group.

In one embodiment of the invention, the publishing client 28 may save a log of the URL sent to the server 12, as shown at block 66. The log may include which publishing group was selected for each URL sent to the server. For example, the log may comprise a table of URLs and the group(s) to which the URLs were sent. The log enables the publishing user to view a publication history of shared content. The publishing client 28 may save the log for a specific time period, such as on a weekly or monthly basis. The publishing client 28 may clear the log after a certain period has elapsed, such as once a week, once a month, etc.

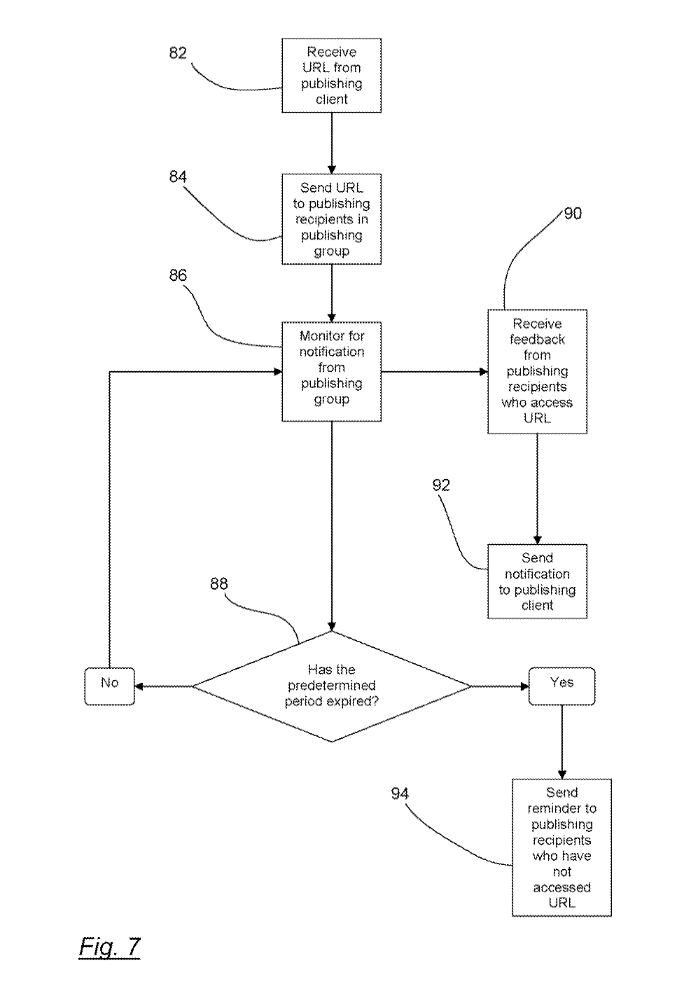

FIG. 7 shows a flowchart of operations which the publishing manager 46 on the server 12 performs under embodiments of the invention. At block 82, the publishing manager 46 receives the URL sent by the publishing client 28, along with an indication of the publishing group for which the URL is intended.

At block 84, the publishing manager 46 sends the received URL to the publishing recipients comprising the chosen publishing group. The publishing manager 46 sends the URL according to the publishing setting configured at block 50 in FIG. 4 above. As explained above, in one embodiment, the content may be published to the publishing group by being pushed out as an RSS (Rich Site Summary) feed to an Internet location. In one embodiment, the content may be published by sending the URL inside an e-mail message to the publishing group. The URL is sent via the network 14. For example, if the publishing user has selected the “Research” group 16, the URL is sent to all the publishing recipients in the “Research” group 16, e.g. one publishing recipient is indicated by reference numeral 22.

At block 86, the publishing manager 46 monitors the publishing group for an indication of whether or not the publishing recipients in the group have accessed the URL sent to them. The publishing manager 46 may monitor the group by awaiting feedback from the publishing recipients over the predetermined period. In one embodiment, each publishing recipient in the group has a computer which includes software similar to the publishing client 28. When a publishing user receives shared content from another publishing user, the first publishing user becomes a publishing recipient, and vice versa. When a publishing recipient receives the URL from the publishing server 12, the publishing client 28 of the recipient checks whether or not the recipient has used that URL to access the shared content. In one embodiment, the publishing client 28 may perform URL matching on a cache of URLs to determine if the shared content has already been accessed. The URL matching may comprise the publishing client 28 comparing the URL of the shared content to a saved history of visited URLS. The history of visited URLs may be saved in the cache by a browser over a period of time. If the URL of the shared content matches a URL saved in the cache, the publishing client 28 sends a notification to the publishing manager 46 to that effect. In one embodiment, the publishing client 28 may send each URL used to access content to the publishing manager 46, so that URL matching may be performed by the server 12. In one embodiment, the publishing client 28 compares URLs received from the publishing manager 46 to the cache in real-time and sends a notification to the publishing manager 46 if the URLs have already been used to access content.

If the publishing manager 46 determines that a publishing recipient has accessed the shared content, as shown at block 90, the publishing manager 46 sends a notification to the publishing user, as shown at block 92. The notification sent to the publishing user will occur in accordance with the notification settings described above in FIG. 4 at block 56. The notification may comprise a time when the URL was used to access the shared content.

As explained, the publishing manager 46 monitors the publishing group for the predetermined period of time, shown at block 88. When the predetermined period expires, for example after two weeks, the publishing manager 46 sends a reminder to all the publishing recipients in the publishing group who failed to access the shared content, as shown in block 94. The reminder may comprise an e-mail message which includes a hyperlink to the shared content, or an instant message to remind the publishing recipient, etc.

Accordingly, it must be appreciated that the invention enables the publishing user to share content hosted on a network to a publishing group, comprising publishing recipients, in an easy-to-use manner without requiring much effort on the side of the publishing user. Once properly configured, embodiments of the invention enable the publishing user to share content simply by clicking a button on a toolbar of a browser. Embodiments of the invention also provide that the publishing user receives feedback concerning which publishing recipients access the shared content. The invention also provides that publishing recipients, who Tail to access the shared content timeousty, are sent a reminder to access the shared content after a predetermined time.

In one embodiment, the publishing server 12 may be configured to cache the shared content. Caching of the shared content may be done as a matter of course, or based on an age of the shared content. For example, all shared content that is more than a predefined number of days old may be cached. In some cases, the publishing client 28 may retrieve the shared content directly from the publishing server 12 by sending a request for the shared content to the publishing server 12. The request may include a user ID and password associated with the publishing client 28 so that the request may be authenticated stored or the publishing server 12, for greater security.

In some cases, shared content may be flagged so that it is permanently stored or bookmarked by the publishing server 12.

In one embodiment, the shared content may be published to a website, intranet, blog, etc.

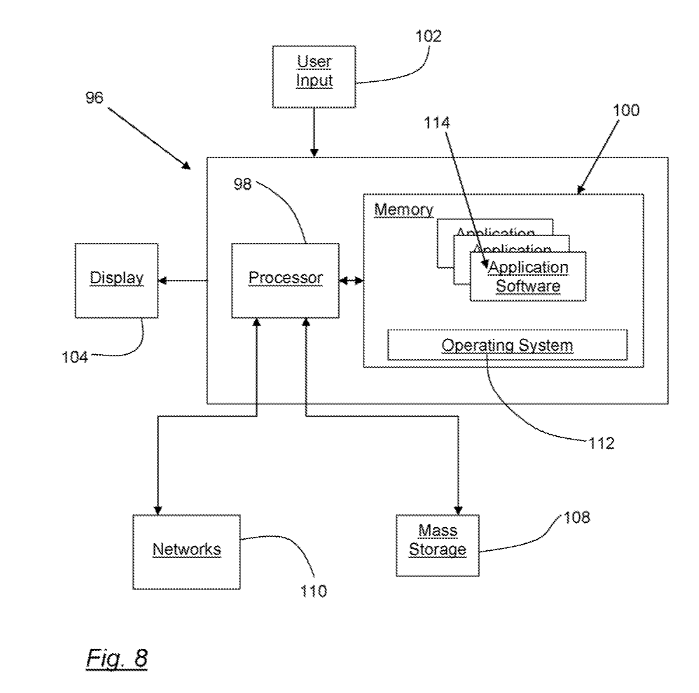

FIG. 8 of the drawings shows an example of hardware 96 that may be used to implement the client computer 10 or the server 12, in accordance with one embodiment of the invention. The hardware 96 includes at least one processor 98 coupled to a memory 100. The processor 98 may represent one or more processors (e.g., microprocessors), and the memory 100 may represent random access memory (RAM) devices comprising a main storage of the hardware 96, as well as any supplemental levels of memory e.g., cache memories, non-volatile or back-up memories (e.g. programmable or flash memories), read-only memories, etc. In addition, the memory 100 may be considered to include memory storage physically located elsewhere in the hardware 96, e.g. any cache memory in the processor 98, as well as any storage capacity used as a virtual memory, e.g., as stored on a mass storage device 108.

The hardware 96 also receives a number of inputs and outputs for communicating information externally. For interface with a user or operator, the hardware 96 may include one or more user input devices 102 (e.g., a keyboard, a mouse, etc.) and a display 104 (e.g., a Liquid Crystal Display (LCD) panel).

For additional storage, the hardware 96 may also include one or more mass storage devices 108, e.g., a floppy or other removable disk drive, a hard disk drive, a Direct Access Storage Device (DASD), an optical drive (e,g. a Compact Disk (CD) drive, a Digital Versatile Disk (DVD) drive, etc.) and/or a tape drive, among others. Furthermore, the hardware 96 may include an interface with one or more networks 110 (e.g., a local area network (LAN), a wide area network (WAN), a wireless network, and/or the Internet among others) to permit the communication of information with other computers coupled to the networks 110. It should be appreciated that the hardware 96 includes analog and/or digital interfaces between the processor 98 and each of the components 100, 102, 104, 108 and 110 as is well known in the art.

The hardware 96 operates under the control of an operating system 112, and executes various computer software applications, components, programs, objects, modules, etc. indicated collectively by reference numeral 114 to perform the above-described operation of the client computer 10, or the server 12. In the case of the server 12, various applications, components, programs, objects, etc. may also execute on one or more processors in another computer coupled to the hardware 96 via a network, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs.” The computer programs comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although the present invention has been described with reference to specific exemplary embodiments, it wilt be evident that various modifications and changes can be made to these embodiments without departing from the broader spirit of the invention. Accordingly, the specification and drawings are to be regarded in an illustrative sense rather than in a restrictive sense.

1. A method comprising:
at the instance of a publishing user, receiving a location on a network at which content to be shared is located;
making the location known to a group of users; and
for each user in the group, providing an indication to the publishing user of whether that user has accessed the content.

2. The method of claim 1, further comprising determining if a user accesses the content within a predefined time period after the location was made known to the group.

3. The method of claim 2, wherein providing the indication comprises notifying the publishing user if the user accesses the content in the predefined period.

4. The method of claim 1 further comprising receiving an already-viewed notification from a user in the group if the content has been accessed by that user before the location of the content was made known to the group.

5. The method of claim 4, wherein providing the indication comprises notifying the publishing user that the user accessed the content before the location of the content was made known to the group

6. The method of claim 2, further comprising sending a reminder to any users in the group that have not accessed the content to access the content.

7. The method of claim 1, wherein group is predefined based on input received from the publishing user.

8. The method of claim 1, wherein the group is predefined based on subscription thereto by each of the users.

9. A method, comprising:
receiving by a client computer of a user from a server, a location at which content is located,
in a case of the content having been accessed by the user prior to the receiving then sending an already-viewed notification to the server to indicate that the content has already been accessed; and
in a case of the content being accessed by the user after the receiving then sending a viewed-notification to the server to indicate that the user has accessed the content.

10. The method of claim 9, determining if the content was accessed prior to the receiving by searching a history associated with a browser of the client computer.

11. The method of claim 9, further comprising displaying at least one publish button in a browser of the client computer and associating the publishing button with a publishing server.

12. The method of claim 11, further comprising upon activation of the publish button by the user, sending the location of content currently being accessed by the browser to the publishing server.

13. The method of claim 12, further comprising allowing to user to add an annotation.

14. A computer readable medium having stored thereon a sequence of instructions which when executed by a processing system causes the system to perform a method comprising:
at the instance of a publishing user, receiving a location on a network at which content to be shared is located;
making the location known to a group of users; and
for each user in the group, providing an indication to the publishing user of whether that user has accessed the content.

15. The medium of claim 14, wherein the method further comprises determining if a user accesses the content within a predefined time period after the location was made known to the group.

18. The medium of claim 15, wherein the method in providing the indication comprises notifying the publishing user if the user accesses the content in the predefined period.

17. The medium of claim 14, wherein the method further comprises sending a reminder to any users in the group that have not accessed the content to access the content.

18. A computer readable medium having stored thereon a sequence of instructions which when executed by a processing system causes the system to perform a method comprising
receiving by a client computer of a user from a server a location at which content is located;
in a case of the content having been accessed by the user prior to the receiving then sending an already-viewed notification to the server to indicate that the content has already been accessed; and
in a case of the content being accessed by the user after the receiving then sending a viewed-notification to the server to indicate that the user has accessed the content.

19. The medium of claim 18, wherein the method further comprises determining if the content was accessed prior to the receiving by searching a history associated with a browser of the client computer.

20. The medium of claim 18, wherein the method further comprises displaying at least one publish button in a browser of the client computer and associating the publishing button with a publishing server.
